(19) United States
(12) Patent Application Publication
(10) Pub. No.: US 2024/0404159 A1
(43) Pub. Date: Dec. 5, 2024

(54) System and Method for a Dynamic Scene-Aware Blending

(71) Applicant: Get Together, Inc. doing business as IRL, Berkeley, CA (US)

(72) Inventors: Loic Ledoux, Schoelcher (FR); Celine Haentzler, Rennes (FR); Nicolas Heriveaux, Bonchamp-lès-Laval (FR); Vincent Leon, Rennes (FR); Theo Rasimi, Versailles (FR)

(21) Appl. No.: 18/203,459

(22) Filed: May 30, 2023

(51) Int. Cl. G06T 13/40; G06T 3/00; G06T 3/40; G06T 15/04; G06T 15/80

(52) U.S. Cl. CPC G06T 13/40; G06T 3/18; G06T 3/4007; G06T 15/04; G06T 15/80

(57) ABSTRACT

A method for embedding a customized visual into an animation-supporting image format, said method comprising the steps of: identifying a customizable area within a source image for minimal-bound cropping; providing a text field for receiving a custom text from a user to be rendered into an image; and mapping the image onto the customizable area based on a linear interpolation of pre-defined texture coordinates.

### BACKGROUND

### Field

This invention relates generally to a system and method for embedding a customized visual into an animation-supporting image format, and more specifically allowing users to embed customized text, emojis, images or even video messages within a selected source file to display as an integrated animation.

### Related Art

It is almost impossible to imagine a digital world without memes, as funny videos, vines, and reels have taken over text on social media. A typical millennial spends more than 200 minutes online each day. According to Statista, the global meme industry was valued at $2.3 billion in 2020. In recent years, memes have become a dominant force on the internet. Memes are images or videos with humorous captions that spread rapidly on social media platforms. They are a powerful form of communication and have changed the way we interact with content online. These humorous images or videos with witty captions have reshaped the way the world engages with online content. What's more, their impact extends beyond entertainment, as memes have disrupted traditional marketing techniques and revolutionized the entire industry.

A profound influence of memes on marketing techniques have ushered in a new era of communication. Memes have emerged as a universal language of connection, uniting people across demographics and cultures. Brands can potentially tap into a vast pool of potential consumers by being fluent in this new lingua franca. By incorporating memes into their marketing strategies, brands can bridge the gap between themselves and their target audience, fostering a deeper sense of relatability and engagement. Additionally, Memes possess a unique ability to go viral within a short span of time. The shareability and relatability of memes make them ideal for capturing attention and generating widespread visibility for brands. By creating memes that resonate with their audience, brands can unleash the power of virality, reaching a larger number of potential customers than traditional marketing methods allow. Social media platforms have become the primary digital playground for internet users. Memes reign supreme in this realm, as they dominate users' feeds and conversations. By leveraging memes, brands can tap into the massive user base and effectively communicate their messages in a format that aligns with the social media culture. This, in turn, leads to increased views, engagement, and brand awareness.

Memes are generated through a creative process involving an original idea or concept paired with an image or video. The process is organic and driven by the internet community, allowing memes to adapt and stay relevant. Captions or text overlays are added to enhance the message. One known meme generator in the industry is Kapwing—an online meme maker and generator tool-which in addition to generating memes, also offers a tool box featuring subtitling, platform-specific resizing, stop-motion, and sound effects. However, Kapwing and the other meme generators lack visual sophistication. They adopt a more straightforward approach by placing a basic layer on top of the desired region for text or image insertion. As a result, their montages may appear more basic and obvious—less visually integrated. In other words, they lack the visual mapping techniques that allow for embedding customized visuals into a selected meme for display as an ‘integrated’ animation. Furthermore, there is a need for a low-latency rendering pipeline, while still being able to deal with the traditional digital graphic challenges, such as shading, occlusion, and perspective.

Therefore, there is a need in the market for a streamlined approach that ensures that users can quickly generate ‘integrated’ memes without having to navigate through multiple customization options or perform extensive graphical modifications.

### SUMMARY

A system of one or more computers can be configured to perform particular operations or actions by virtue of having software, firmware, hardware, or a combination of them installed on the system that in operation causes or causes the system to perform the actions. One or more computer programs can be configured to perform particular operations or actions by virtue of including instructions that, when executed by data processing apparatus, cause the apparatus to perform the actions.

In an embodiment of the invention, a method for embedding a customized visual into an animation-supporting image format comprises the steps of, identifying a customizable area within a source image for minimal-bound cropping, providing a text field for receiving a custom text from a user to be rendered into an image and mapping the image onto the customizable area based on a linear interpolation of pre-defined texture coordinates. Further yet, the animation-supporting image format is at least one of a Graphics Interchange Format (GIF), Vector-Based Image Format (SVG), or an Animated or Static Portable Network Graphic (PNG). Additionally, the source file comprises a pre-identified customizable area for minimal bound cropping and belongs to a plurality of source files in a curated library for user selection and embedding of a customized visual within the minimal bound cropped area. Thus, enabling users to customize images by adding their own text and embedding it into a specific region of the source image, resulting in an animation-supporting image format suitable for various applications.

In yet another embodiment of the invention, a method for embedding a customized visual into an animation-supporting image format comprises the steps of, providing a text field for receiving a custom text from a user to be rendered into an image, mapping the image onto a pre-identified customizable area of a source file based on a linear interpolation of pre-defined texture coordinates and preprocessing constant pixel ranges at the beginning and end of rows to reduce computation. Furthermore, in another embodiment of the invention, the preprocessing identifies the number of constant pixels at the beginning of the row and the number of constant pixels at the end of the row and the constant pixel range at the beginning and end of rows is excluded from the mapping computation. Furthermore, the mapping interpolates between prepared images rather than whole images and is performed by using per-pixel coordinates and multiple mapped image pixels for a single output pixel to enable filtering and avoid aliasing and pixelation artifacts. This embodiment of the method allows users to input custom text, map it onto a specific area of a source file using linear interpolation and pre-defined texture coordinates, and preprocessor constant pixel ranges to optimize the computation. The method also employs interpolation between prepared images to enhance the quality of the output and avoid artifacts. The resulting image is then saved in an animation-supporting image format.

In yet another embodiment of the invention, a system for embedding a customized visual into an animation-supporting image format comprises a processor, a non-transitory storage element coupled to the processor, encoded instructions stored in the non-transitory storage element, wherein the encoded instructions when implemented by the processor, configure the system to identify a customizable area within a source image for minimal-bound cropping, provide a text field for receiving a custom text from a user to be rendered into an image and map the image onto a minimal-bound cropped area of a user selected source image based on a linear interpolation of pre-defined texture coordinates. Furthermore, the system further comprises an interface allowing for the user to identify a customizable area for embedding the custom text. Additionally, the system further comprises an interface allowing for the user to upload an image format for self-identifying or system-identifying candidates for a customizable area. Additionally, the system further comprises an interface for allowing integration with social media platforms for sharing source files with embedded customized visuals or receiving source files.

Furthermore, the mapping technique employed is a homography-based 2D composting technique that leverages the power of 3D rendering engines to offer a superior solution with efficient and realistic results. It simplifies the computational pipeline by using 2D texture mapping for perspective and non-rigid transformations, eliminates complex 3D calculations by employing masking techniques for occlusion handling, and achieves realistic shading effects via pre-computed reflectance maps. Thus, reducing computational complexity and resource requirements—ideal for high volume, low-latency applications, such as meme generating.

Other embodiments include aspects corresponding to computer systems, apparatus, and computer programs recorded on one or more computer storage devices, each configured to perform the actions of the methods.

### BRIEF DESCRIPTION OF THE DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1A illustrates a network diagram, according to an embodiment of the invention.

FIG. 1B illustrates a network diagram, according to an embodiment of the invention.

FIG. 2 illustrates a block diagram, according to an embodiment of the invention.

FIG. 3 illustrates a block diagram, according to an embodiment of the invention.

FIG. 4 illustrates a block diagram, according to an embodiment of the invention.

FIG. 5 illustrates a method flow diagram, according to an embodiment of the invention.

FIG. 6. illustrates a graphical representation, according to an embodiment of the invention.

FIG. 7A illustrates a source image, according to an embodiment of the invention.

FIG. 7B illustrates a source image, according to an embodiment of the invention.

FIG. 8 illustrates an exemplary screen shot, according to an embodiment of the invention.

FIG. 9 illustrates an exemplary screen shot, according to an embodiment of the invention.

FIG. 10 illustrates an exemplary screen shot, according to an embodiment of the invention.

FIG. 11 illustrates an exemplary screen shot, according to an embodiment of the invention.

FIG. 12 illustrates an exemplary screen shot, according to an embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. These embodiments are provided so that this disclosure will be thorough and complete, and will fully convey the scope of the disclosure to those skilled in the art.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

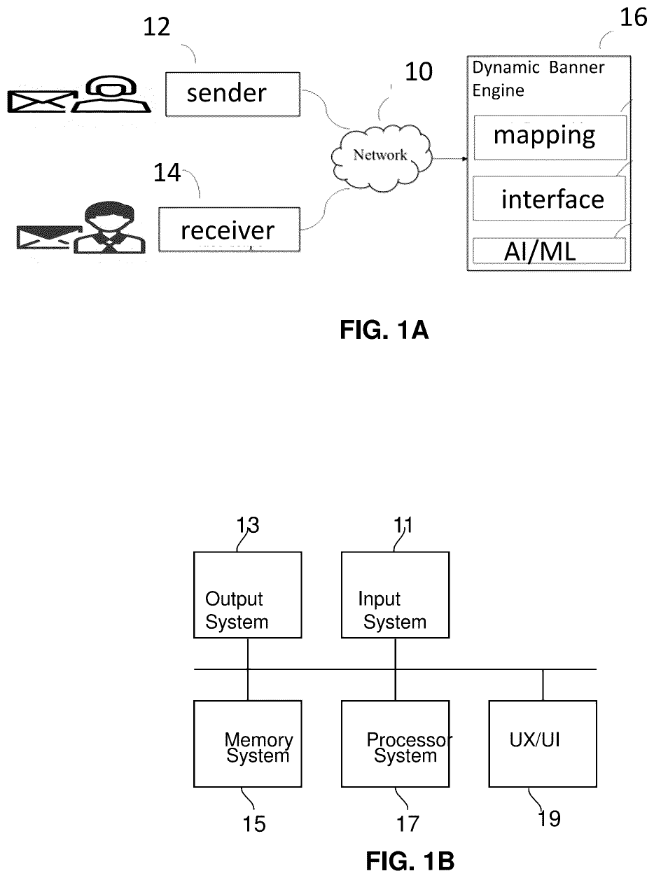

Specific embodiments of the invention will now be described in detail with reference to the accompanying FIGS. 1A-11. In the following detailed description of embodiments of the invention, numerous specific details are set forth in order to provide a more thorough understanding of the invention. In other instances, well-known features have not been described in detail to avoid obscuring the invention.

### Exemplary Environment:

FIG. 1A illustrates a network diagram of the system and method for embedding a customized visual into an animation supporting image format. The networked environment includes a sender 12, a receiver 14 and a processing unit 16. The sender 12, receiver 14 and the processing unit 16 are communicatively coupled through a network 10. In an exemplary embodiment, the network 10 facilitates communication between a processor 16, a sender, and a receiver, wherein the processor 16—featuring at least a mapping, interface, and cursor control module—is configured to enable a sender 12 to embed a customized visual into an animation-supporting image format by
providing a text field for receiving a custom text from the sender 12 to be rendered into an image; and mapping the image onto a customizable area of a selected source image based on a linear interpolation of pre-defined texture coordinates.

In continuing reference to FIG. 1A, the network 10 may be any suitable wired network, wireless network, a combination of these or any other conventional network, without limiting the scope of the present invention. Few examples may include a LAN or wireless LAN connection, an Internet connection, a point-to-point connection, or other network connection and combinations thereof. The network 10 may be any other type of network that is capable of transmitting or receiving data to/from host computers, personal devices, mobile phone applications, video/image capturing devices, video/image servers, or any other electronic devices. Further, the network 10 is capable of transmitting/sending data between the mentioned devices. Additionally, network 10 may be a local, regional, or global communication network, for example, an enterprise telecommunication network, the Internet, a global mobile communication network, or any combination of similar networks. The network 10 may be a combination of an enterprise network (or the Internet) and a cellular network, in which case, suitable systems and methods are employed to seamlessly communicate between the two networks. In such cases, a mobile switching gateway may be utilized to communicate with a computer network gateway to pass data between the two networks. The network 10 may include any software, hardware, or computer applications that can provide a medium to exchange signals or data in any of the formats known in the art, related art, or developed later.

FIG. 1B illustrates an exemplary bus diagram for a system and method for embedding custom visuals onto animation supporting image formats. The processor system 17 is configured to process the stored data and interpolate a 2-D rendered image of the customized visual onto a predefined customizable area in a source file selected from a library of source files.

The input system 11 is configured to receive a user selected source file, including for searching or scrolling through a library of pre-processed source files, and further receiving a text caption from the user to be embedded. The output system 13 is configured to present the visual representation of the embedding (‘integrated’ meme) via 2-D texture mapping, along with meta-data (optionally). The UX/UI system 19 is configured to provide an intuitive and interactive interface for the user to further graphically process the embedded animation supporting image format using a pointing device control.

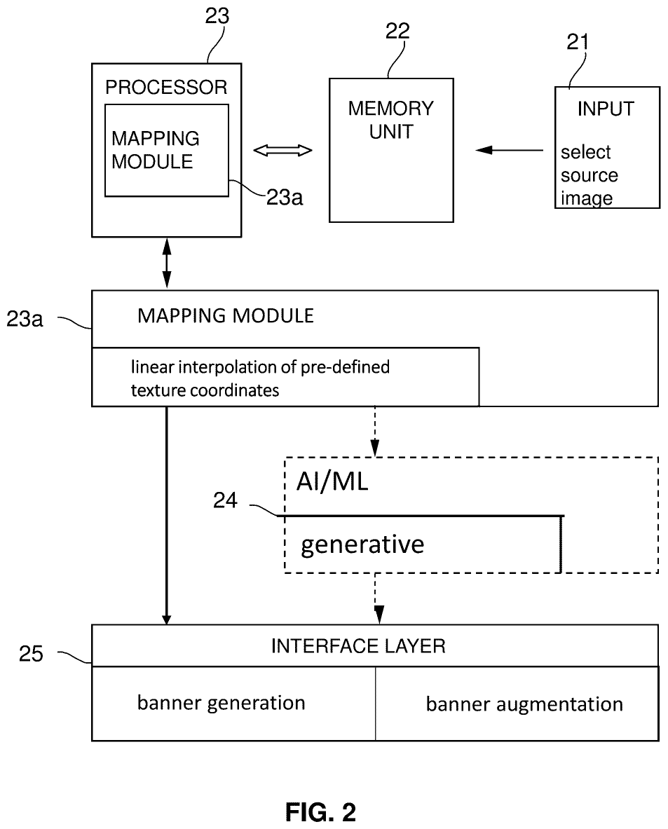

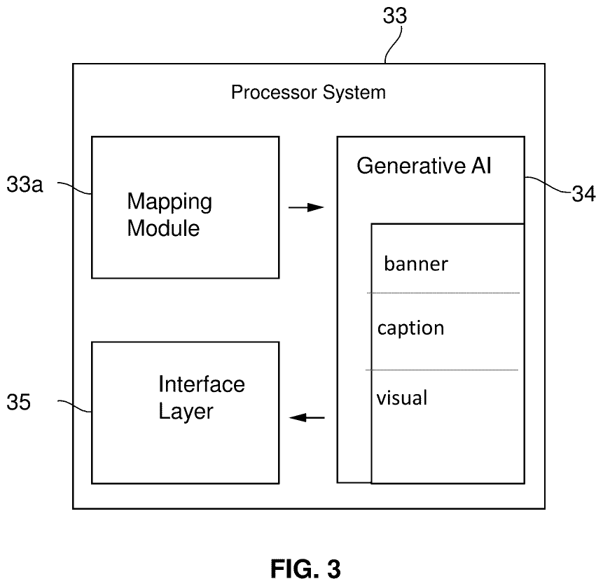

Now in reference to FIGS. 2 and 3, which collectively illustrate an exemplary system flow diagram in accordance with an aspect of the invention. More particularly, FIG. 2 illustrates an exemplary global system interaction, while FIG. 3 highlights the processor, detailing individual modules composed within and, or interacted between. FIG. 2 illustrates a block diagram of the system comprising an input event 21, a memory unit 22 in communication with the input event 21, a processor 23 in communication with the memory unit 22, a processor 23 (further comprising and, or in communication with a mapping module 23a, optionally, an AI/ML module or generative AI module 24, and an interface layer module 25. In an embodiment, the memory unit 22 is a non-transitory storage element storing encoded information. The encoded instructions when implemented by the processor 23, configure the system to identify a customizable area (pre-defined, or optionally, user-defined) within a source image for minimal-bound cropping; provide a text field for receiving a custom text from a user to be rendered into an image; and map the image onto a minimal-bound cropped area of a user selected source image based on a linear interpolation of pre-defined texture coordinates.

As FIG. 3 depicts, the mapping module 33a may perform a series of complex operations to generate custom embedded visuals into a GIF-type file or any animation supporting image format. These operations involve identifying areas of interest within the source image, generating custom visual elements based on user input, and mapping these elements onto the areas of interest on the source image in a seamless and visually pleasing manner, outputting a seamlessly ‘integrated’ animation supporting image format via the interface layer 35.

Still in reference to FIG. 3, the mapping module 33a and interface layer 35 may be communicatively coupled to a generative AI module/model 34 for further influencing the creation, dissemination, and engagement with viral GIF files, thanks to its capability to generate a myriad of visual variations from a single GIF or animation. With generative AI, different versions of the same GIF file could be created, adjusting specific visual elements like banners, captions, colors, lighting, shading, and more. This not only adds a sense of novelty to the GIF but also presents an opportunity to further personalize the content based on user preferences. For instance, generative AI could develop thousands of variations of a popular meme to cater to various languages, cultural contexts, or personal tastes, thereby increasing its reach and engagement.

Moreover, the ability to regenerate GIFs or animations also lends more adaptability to the content. A GIF with seasonal elements, for example, could be adapted throughout the year, keeping the content fresh and relevant. Coupled with the scalability provided by generative AI, the creation of such GIFs can be amplified dramatically. Instead of a human designer manually creating each version, the AI can generate numerous versions quickly, allowing for more experimentation and the creation of more niche content.

Generative AI could also help to bolster engagement by incorporating elements currently trending or popular. By tracking trending topics or memes and incorporating these into the GIFs it generates, an AI could significantly increase the chances of a GIF going viral. Furthermore, the AI can adjust metadata like captions and tags to align with trending keywords or user search behavior, thus increasing the likelihood of discovery and shareability. This technology can also facilitate more effective A/B testing of GIFs, with different versions disseminated to different audiences, and the AI learning from which versions achieve the most success in terms of engagement and sharing.

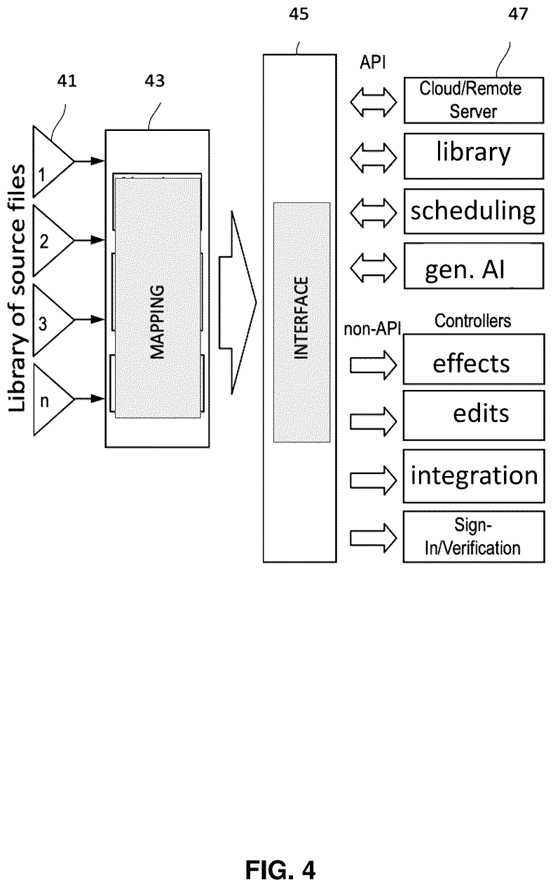

FIG. 4 illustrates in a block diagram form, an interaction flow between a mapping module 43 and the interface layer 45 to allow users to embed customized visuals into an animation supporting image format (GIF memes, for instance), according to an exemplary embodiment. According to an embodiment, the system is configured to identify a customizable area within a source image for minimal-bound cropping; provide a text field for receiving a custom text from a user to be rendered into an image; and map the image onto a minimal-bound cropped area of a user selected source image based on a linear interpolation of pre-defined texture coordinates. The embedded meme may be sent to a cloud/remote server for additional analytics and provisioning 47, controlled via the interface layer 45, including for reports, updates, alerts, export options or store options to save, search, print or email and a sign-in/verification unit.

### Examples of Additional Provisioning (Local/Remote) Via the Interface Layer:

Filter and Effects Application: Users could apply various visual effects and filters to their custom memes or GIFs to add artistic flair or visual interest. This might include color corrections, vintage filters, or special effects like light leaks or motion blurs.

Text Editing: Advanced text editing tools could allow users to customize the font, size, color, and style of any text they add to their meme or GIF. They could also include functionality for adding text animations or special effects, like drop shadows or glows.

Layer Management: If users are adding multiple elements to their meme or GIF, layer management tools could make the creation process more manageable. This might include the ability to re-order layers, group related layers together, or toggle layers on and off.

Template Library: A library of pre-made templates could help users get started with their meme or GIF creation. These could range from simple layouts to more complex designs, and users could customize them as needed. Furthermore, an embodiment may feature a library of user-uploaded source files for downstream banner (customizable area) identification. In yet other embodiments, the user may upload a source file and banner identify themselves.

Smart Crop and Resize: Tools that automatically crop or resize the meme or GIF based on the platform it will be posted on can be handy. For example, a tool could automatically adjust the dimensions for Instagram's square format or Twitter's rectangular format.

Collaboration Features: If multiple users are working on a meme or GIF together, collaboration tools could allow them to work on the same file simultaneously. This could include features for leaving comments or suggestions, tracking changes, and more.

Scheduled Posting: For users who want to post their meme or GIF at a specific time, scheduled posting tools could allow them to set a date and time for their post to go live.

Performance Analytics: Users may want to track the performance of their meme or GIF once it's posted. Tools could provide metrics like views, shares, likes, comments, and overall reach. The suite of tools could include analytics tools that provide users with data on the performance of their GIFs or memes, such as how many times they were viewed, shared, or liked, and on which platforms. This could help users understand what types of content are most successful and adjust their strategy accordingly.

Generative AI Suggestions: As previously discussed, integrating a generative AI model could provide suggestions for optimal areas for customization based on the specific content of the custom text or visuals, or based on current trends. The AI could also suggest different variations of customization to provide users with a broader range of options.

Real-Time Preview: A tool that allows users to preview their customized GIF or meme in real-time as they make changes. This could include showing how the GIF will look when posted on various social media platforms.

Version Control: This function would allow users to track changes made to a GIF or meme over time, revert back to previous versions if needed, and compare different versions. This is especially useful in collaborative settings.

Integration with Other Platforms: Providing easy integration with other platforms, such as photo editing software, social media management tools, or content management systems, could streamline the workflow for creating, managing, and posting GIFs or memes.

Accessibility Features: Tools to ensure the content created is accessible to all users, such as text-to-speech for any embedded text, alt text for images, or color-blind friendly design options.

Trend Insights: The system could provide insights into current GIF or meme trends, helping users to create content that is more likely to be popular or go viral. This tool could use data from social media and other sources to identify trending styles, themes, or elements.

Multilingual Support: The system could offer multilingual support, allowing users to create GIFs or memes in different languages. This would be particularly useful for users who want to disseminate their GIFs or memes to a global audience.

The inclusion of these tools and functions could enhance the user experience, increase the system's versatility, and make the creation, customization, and dissemination of GIFs or memes more effective and accessible.

### Exemplary Process:

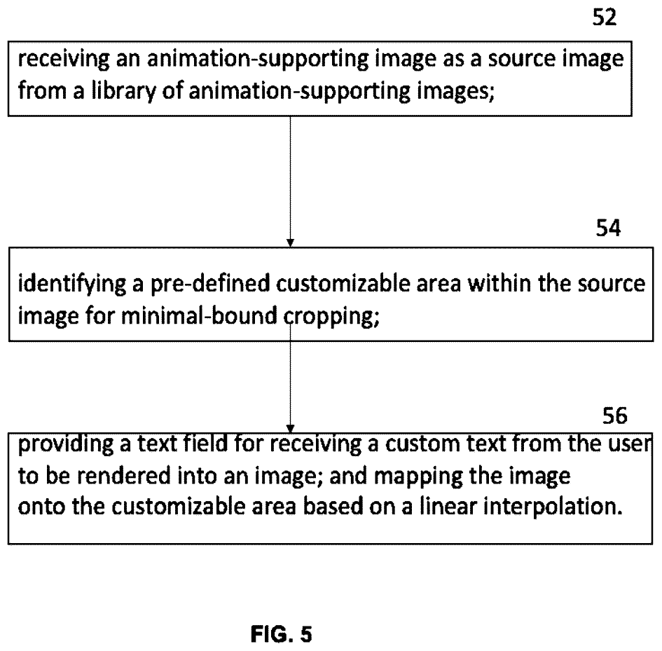

FIG. 5 illustrates an exemplary method flow of the system, comprising the steps of: receiving an animation-supporting image as a source image from a library of animation supporting images 52; identifying a pre-defined customizable area within the source image 54; and providing a text field and, or any input field for receiving a custom text and, or visual from the user to be rendered into an image and mapping said image onto the customizable area by the mapping module employing a mapping technique 56.

### 2-D Texture Mapping Technique:

The mapping technique employed by the mapping module is based on pre-defined texture coordinates that are known in advance for each pixel of the customizable area. This differs from 3-D texture coordinates, which are defined per vertex and computed in the fragment shader. For each customizable pixel, the mapping module has one or more data couples indicating the index of the pixel in the mapped image to use and the weight to apply to that pixel. By using multiple mapped image pixels for a single output pixel, the mapping module enables filtering and avoids aliasing and pixelation artifacts.

To generate the mapping data, the mapping module creates an additional image sequence with a 2-D gradient image. This gradient image provides the matching U,V coordinates when read. The mapping module then uses the dimensions of the mapped image to compute the index of the source pixel for a top-to-bottom row-packed bitmap. Once the mapping data has been generated, the mapping module maps the custom visual element onto the customizable area of the source image by calculating the sum of the weighted RGB values of the mapped image pixels. This produces the resulting color for each customizable pixel, which is expressed as follows: Custom_ColorRGB=Sum (Weightn*Mapped_Image_Pixels[Indexn]RGB).

Overall, the mapping technique employed by the mapping module is a complex process that involves generating mapping data from a 2-D gradient image, computing the index of the source pixel for a top-to-bottom row-packed bitmap, and mapping the custom visual element onto the customizable area of the source image using pre-defined texture coordinates and weighted RGB values. This technique enables the mapping module to seamlessly blend the custom visual element into the source image and produce a visually pleasing output.

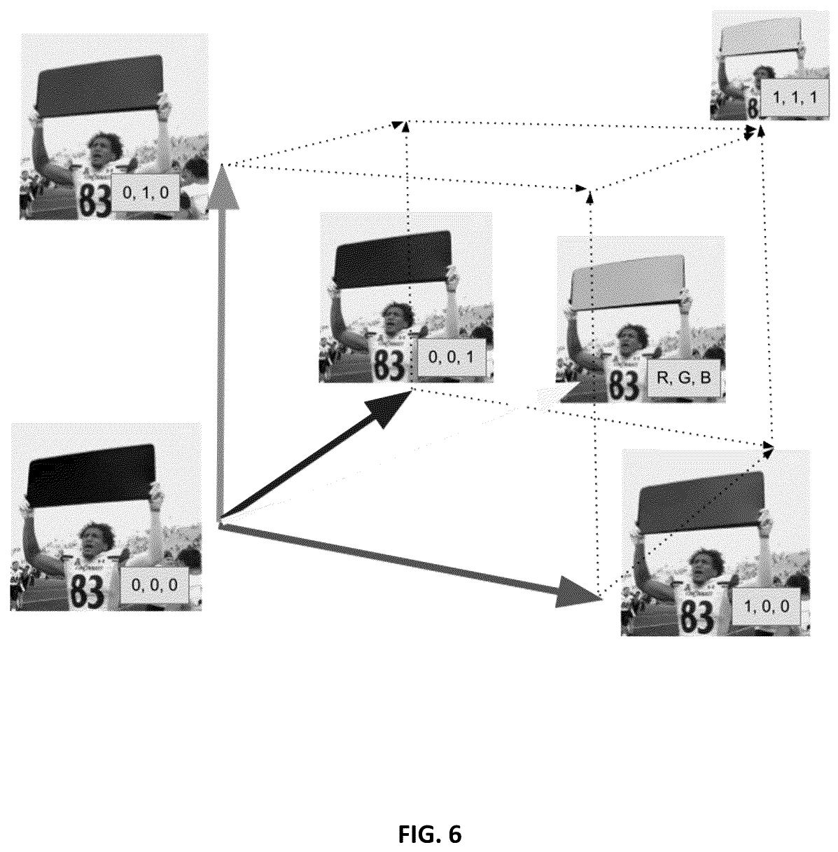

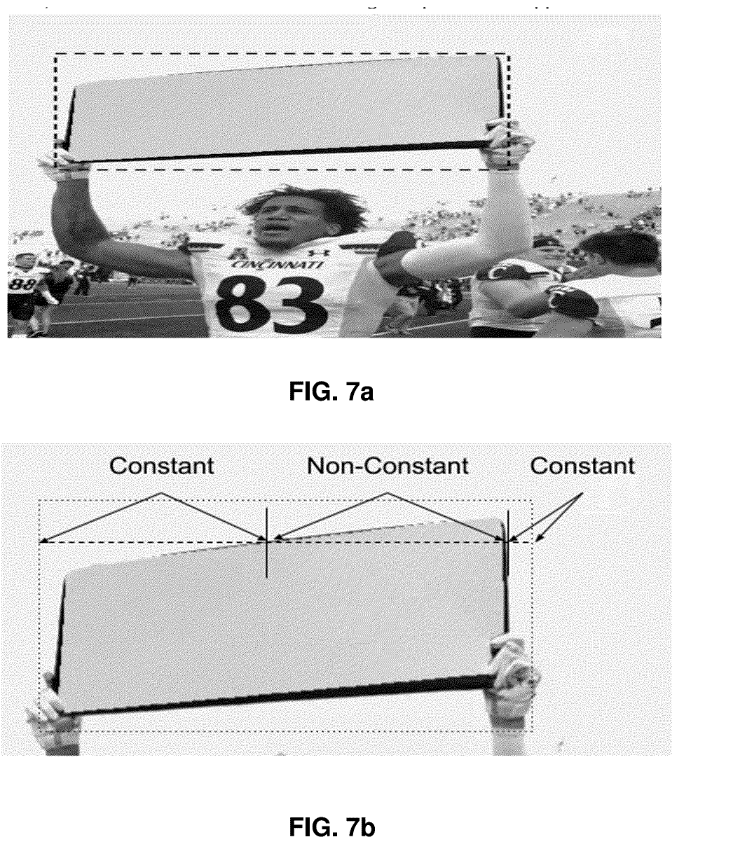

In reference now to FIGS. 6, 7a, and 7b, which collectively illustrate a source image being embedded with a custom visual using the 2-D texture mapping technique. The 2-D texture technique used in the process of embedding custom visuals into memes or animation supporting image formats (GIFs) offers several advantages over other methods. In traditional 3-D rendering techniques, shading computation involves complex calculations for the reflection, refraction, and absorption of light. Additionally, 3-D rasterization involves converting 3-D geometry into a 2-D image by projecting the geometry onto a 2-D plane and filling in the resulting pixels with color and texture information. These processes can be computationally intensive, particularly for high-volume and low-latency generation services.

The proposed 2-D texture technique provides a more efficient approach by utilizing a 2-D-only computational pipeline that preserves perspective, shading, and occlusion. The technique combines the benefits of both 2-D and 3-D techniques while minimizing their drawbacks. One of the key advantages is the ability to handle perspective and non-rigid transformations effectively without the need for complex 3-D rendering processes. This simplification reduces computational overhead and makes the approach more efficient, particularly for high-volume and low-latency applications.

Another advantage of the 2-D texture technique is its ability to address the issue of occlusions by implementing masking techniques. By selectively hiding or revealing parts of the texture based on depth information, the approach effectively conveys depth ordering in the composite image. This eliminates the need for complex 3-D calculations and rendering, thus making the solution more lightweight and faster than traditional 3-D rendering engine techniques.

Furthermore, the technique uses pre-computed reflectance maps to handle shading effectively without the need for resource-intensive shading computation and 3-D rasterization. By storing and using shading information from a pre-calculated source, the approach achieves realistic shading effects with significantly reduced computational costs.

In summary, the 2-D texture technique used in the process of embedding custom visuals into memes or animation supporting image formats offers a superior solution by combining the benefits of both 2-D and 3-D techniques while minimizing their drawbacks. By leveraging 2-D texture mapping, masking techniques, and pre-computed reflectance maps, the approach delivers realistic 3-D effects in composite images without the computational complexity and resource requirements of traditional 3-D rendering techniques. This efficiency makes the approach particularly well-suited for high-volume, low-latency generation services, setting it apart from existing methods in the field of meme generating.

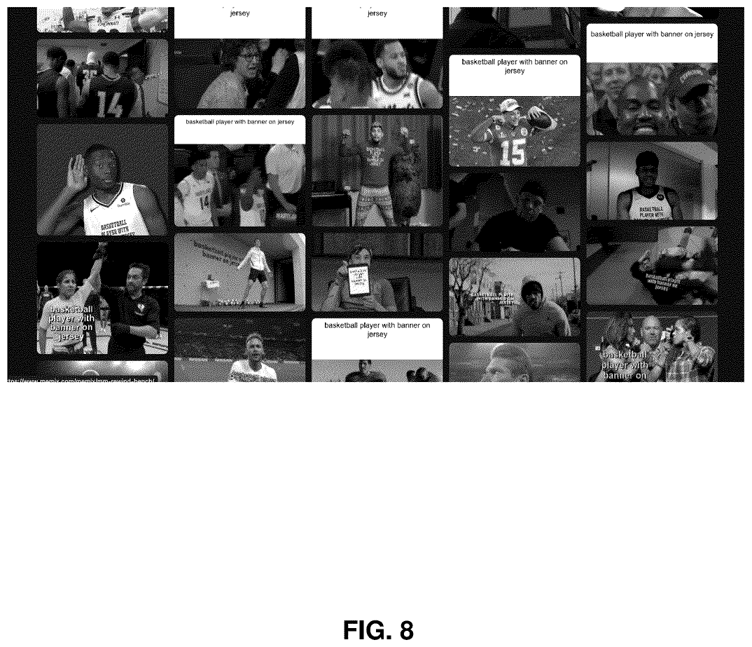

Now in reference to FIGS. 8-12, which are each screenshots representing a different step in the user experience embedding custom visuals into a selected source file to generate an otherwise familiar animation supporting image with a customized, dynamic banner.

### Source File Selection:

As illustrated in FIG. 8, the first step entails the user being presented with a library of scrollable thumbnails, each representing a different source file or template supporting animation. The library may be presented as a default landing site, keyword search-routed, or category-routed. These files come with pre-identified banners or customizable areas. The user can explore this gallery and make a selection based on their preference or the specific concept they want to express in their meme.

### Choosing a Caption Template:

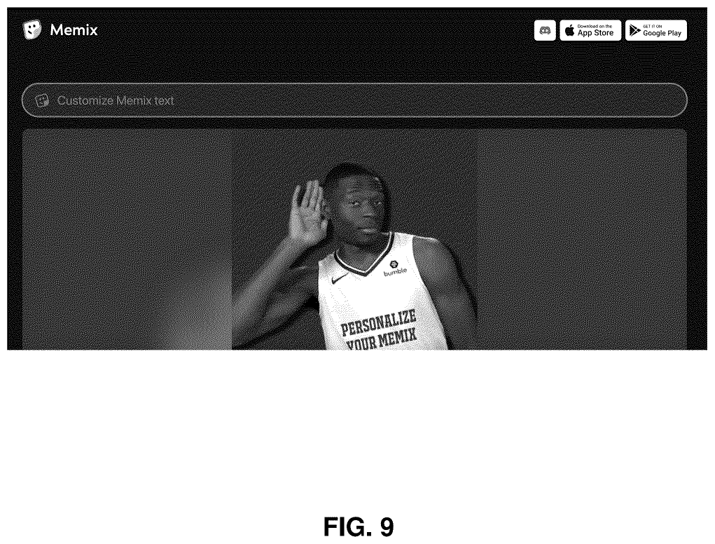

In FIG. 9, upon selecting the source file, the user is taken to the next step where they can choose a caption template from a library. For instance, in this figure, the user has selected a meme featuring basketball player Mfiondu Kabengele, dressed in a white jersey. The front of the jersey acts as the predefined banner or customizable area for the user.

### Entering Custom Text:

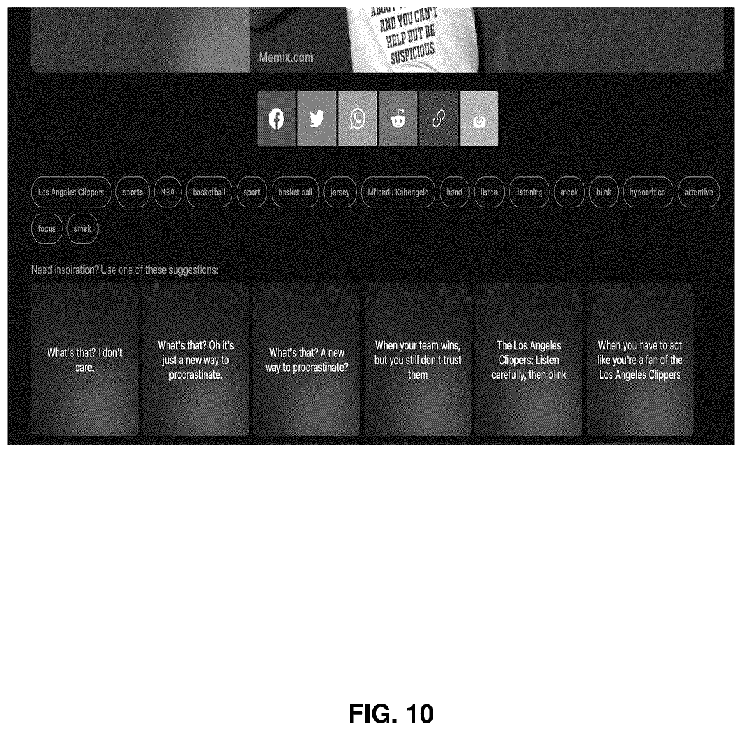

Here, in FIG. 10, the user is presented with a number of pre-filled captions or caption templates to choose from. However, they have the freedom to disregard the suggestions and input their own custom text. In this case, they choose to enter the text: “When you hear someone talking about the Knicks and you just can't take it seriously.”

### Viewing Customized Visual:

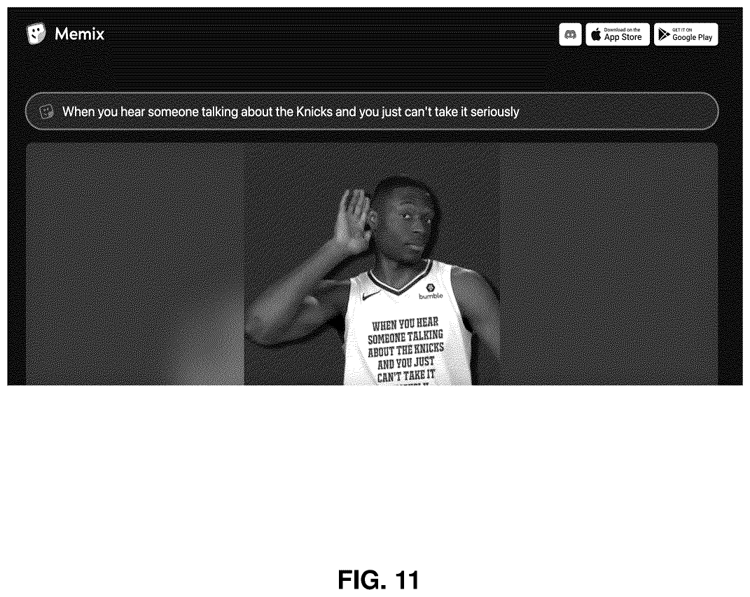

At this stage, the screenshot of FIG. 11 highlight the user getting to see their customized visual in its integrated animation form in real-time or near real-time. This step is vital as it allows the user to preview their creation, and if needed, go back to the previous steps to make changes.

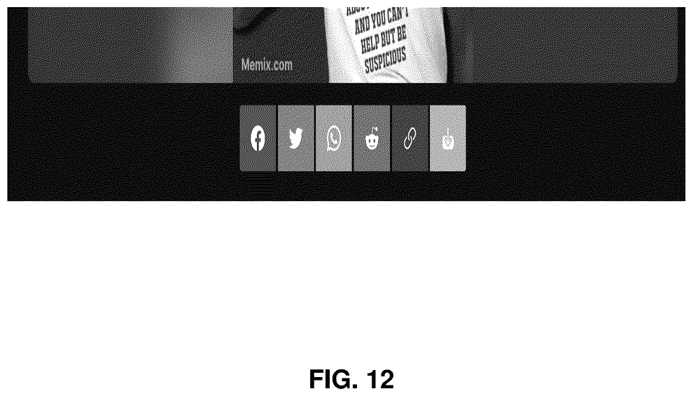

Archival and Posting Options: Finally, in the last step of FIG. 12, the user is presented with a suite of options for what they can do with their newly created meme. They can choose to archive the meme for future use, or they can directly post it onto their social media platforms. This step could also provide options for downloading the meme or sharing it with others via email or messaging platforms.

As an additional feature, the application could offer downstream analytics for the user to track the performance of their memes, as well as any additional provisioning options like scheduling posts, setting reminders, etc. Throughout this user journey, the application offers an intuitive and user-friendly way of creating customized “integrated” memes or memes with a customized and dynamic banner. With a dynamic banner, the custom text or visuals are not just statically overlayed on the GIF or meme but are also dynamically adjusted in response to the changes in the underlying animation.

In the example provided, the text on Mfiondu Kabengele's jersey would dynamically reconfigure as Kabengele moves. So, if the text or visual is on the jersey and he raises his arm, the text would also move and distort realistically in sync with the jersey's movement. This level of customization could significantly enhance the overall aesthetic and immersive qualities of the GIFs or memes. For instance: The custom text or visuals would change in a way that is consistent with the underlying animation, thereby maintaining the integrity of the original animation and enhancing the realism of the custom element.

The dynamic changes in the custom text or visuals could catch the viewer's attention and make the GIF or meme more engaging. The viewer might even watch the GIF multiple times to catch all the nuances of how the custom element changes. Also, the customized visual or text could be tailored to the recipient in order to increase the prospect of being opened and viewed by the recipient. For instance, Mo generates a familiar meme of a baby with a pumped first featuring a dynamic bannered caption embedded on his t-shirt reading “Jerry, you're next!”. As a result, Jerry, upon receiving the meme in a text message format, will be able to preview the meme with Jerry's name prominently featured on the baby's t-shirt and immediately grab Jerry's attention and intrigue.

In this way, offering a deeper level of customization through dynamic banners could take the creation of GIFs and memes to a new level, offering users more creative freedom and enhancing the viewing experience. Such dynamic and integrative customization could lead to more authentic and impactful expressions in the animations. Additionally, the visually responsive nature of the dynamic banner would lend an element of realism and depth to the GIFs or memes, making them more engaging and memorable. Users could leverage this feature to create visually compelling and creative content, thereby enhancing their interaction and engagement with the GIF or meme.

The figures illustrate the architecture, functionality, and operation of possible implementations of systems, methods and computer program products according to various embodiments of the present invention. It should also be noted that, in some alternative implementations, the functions noted/illustrated may occur out of the order noted. For example, two blocks shown in succession may, in fact, be executed substantially concurrently, or the blocks may sometimes be executed in the reverse order, depending upon the functionality involved.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art of creating independent multi-layered virtual workspace applications designed for use with independent multiple input systems that although the preferred and alternate embodiments have been shown and described in accordance with the Patent Statutes, the invention is not limited thereto or thereby.

Some portions of embodiments disclosed are implemented as a program product for use with an embedded processor. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid-state disk drive, etc.); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention may be part of an operating system or a specific application, component, program, module, object, or sequence of instructions. The computer program of the present invention typically consists of a multitude of instructions that will be translated by the native computer into a machine-accessible format and hence executable instructions. Also, programs are composed of variables and data structures that either reside locally to the program or are found in memory or on storage devices. In addition, various programs described may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

We claim:

1. A method for embedding a customized visual into an animation-supporting image format, said method comprising the steps of:
identifying a customizable area within a source image for minimal-bound cropping;
providing a text field for receiving a custom text from a user to be rendered into an image; and
mapping the image onto the customizable area based on a linear interpolation of pre-defined texture coordinates.

2. The method of claim 1, wherein the animation-supporting image format is at least one of a Graphics Interchange Format (GIF), Vector-Based Image Format (SVG), or an Animated or Static Portable Network Graphic (PNG).

3. The method of claim 1, wherein the source file comprises a pre-identified customizable area for minimal bound cropping.

4. The method of claim 3, wherein the customizable area for minimal bound cropping is identified based on at least one of a: dimension, planar characteristics, or motion of a candidate banner for visually mapping the custom text.

5. The method of claim 3, wherein the source file is among a plurality of source files in a curated library for user selection and embedding of a customized visual within the minimal bound cropped area.

6. The method of claim 1, wherein the mapping uses per-pixel coordinates to map the custom text onto the customizable area.

7. The method of claim 6, wherein the mapping of the custom text using per-pixel coordinates enables filtering, avoiding aliasing and pixelation artifacts.

8. The method of claim 6, wherein the mapping uses a 2D approach for template production.

9. A method for embedding a customized visual into an animation-supporting image format, said method comprising the steps of:
providing a text field for receiving a custom text from a user to be rendered into an image; and
mapping the image onto a pre-identified customizable area of a source file based on a 2-D texture mapping.

10. The method of claim 9, further comprising a preprocessing identifying the number of constant pixels at the beginning of the row and the number of constant pixels at the end of the row to reduce computation.

11. The method of claim 10, wherein the constant range at the beginning and end of rows are excluded from the mapping computation.

12. The method of claim 9, wherein the mapping interpolates between prepared images rather than rendering whole images.

13. The method of claim 9, wherein the mapping is performed using per-pixel coordinates and multiple mapped image pixels for a single output pixel to enable filtering and avoid aliasing and pixelation artifacts.

14. The method of claim 9, wherein the mapping utilizes pre-computed reflectance maps to handle shading.

15. The method of claim 9, wherein the mapping employs masking techniques to address the issue of occlusions, selectively hiding or revealing parts of the texture based on depth information to effectively convey depth ordering in the image.

16. The method of claim 9, wherein the mapping utilizes pre-calculated shading information from a pre-computed source, to achieve realistic shading effects in the image.

17. The method of claim 9, wherein the mapping utilizes perspective transformation techniques to align and warp the texture to match the source file perspective.

18. A system for embedding a customized visual into an animation-supporting image format, said system comprising:
a processor;
a non-transitory storage element coupled to the processor;
encoded instructions stored in the non-transitory storage element, wherein the encoded instructions when implemented by the processor, configure the system to:
identify a customizable area within a source image for minimal-bound cropping;
provide a text field for receiving a custom text from a user to be rendered into an image; and
map the image onto a minimal-bound cropped area of a user selected source image based on a linear interpolation of pre-defined texture coordinates.

19. The system of claim 18, further comprising an interface allowing for the user to identify a customizable area for embedding the custom text.

20. The system of claim 18, further comprising an interface allowing for the user to upload an image format for self-identifying or system-identifying candidates for a customizable area.

21. The system of claim 18, further comprising an interface for allowing integration with social media platforms for sharing source files with embedded customized visuals or receiving source files.

22. The system of claim 18, further comprising an interface for integrating with third-party applications or websites for sharing source files with embedded customized visuals or receiving source files.

23. The system of claim 18, further comprising an interface to navigate the library for different categories or themes to provide a diverse selection of source files for custom embedding.

24. The system of claim 18, further comprising an interface layer for allowing the user to navigate the library of source files for pre-filled and customizable templates.
